(19) United States
(12) Patent Application Publication
(10) Pub. No.: US 2024/0132161 A1
(43) Pub. Date: Apr. 25, 2024

(54) COMBINATION ADDITIVE MANUFACTURED STRUCTURES AND METHODS

(71) Applicant: Divergent Technologies, Inc., Los Angeles, CA (US)

(72) Inventor: Michael Thomas KENWORTHY, Rancho Palos Verdes, CA (US)

(21) Appl. No.: 18/490,550

(22) Filed: Oct. 18, 2023

Related U.S. Application Data
(60) Provisional application No. 63/417,908, filed on Oct. 20, 2022.

(51) Int. Cl. B62D 27/02; B62D 29/00

(52) U.S. Cl. CPC B62D 27/026; B62D 29/005; B33Y 80/00

(57) ABSTRACT

A vehicle component and method of forming a vehicle component. The vehicle component includes an additively-manufactured (AM) structure with a first end and a second end opposing the first end. The AM structure includes a pathway from the first end to the second end and a non-AM structure that passes along the pathway from the first end to the second end. The non-AM structure and the AM structure are fixedly connected to one another at a connection.

### CROSS-REFERENCE TO RELATED APPLICATION

This application claims the benefit of U.S. Provisional Application No. 63/417,908 filed on Oct. 20, 2022, titled: SCAFFOLDING BASED STRUCTURE, the entirety of which is incorporated by reference herein.

### FIELD

The present disclosure relates generally to combined additively manufactured and non-additively manufactured components and methods of forming combined components.

### BACKGROUND

Additive manufacturing (AM) systems can produce metal structures (referred to as build pieces) with geometrically complex shapes, including some shapes that are difficult or impossible to create with conventional manufacturing processes. (AM) techniques are used to create build pieces layer-by-layer, i.e., slice-by-slice. The process can be repeated to form the next slice of the build piece, and so on. Because each layer is deposited on the previous layer, AM allows for the formation of structures that were previously not possible to be formed by traditional non-AM manufacturing technologies.

While AM provides several advantages, frequently any one or combination of efficiency, cost, and/or scale of a project may result in AM not being ideal for formation of all components.

### SUMMARY

The following presents a simplified summary of one or more aspects of the invention in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

In some aspects of this disclosure, a combination component or structure that may be a vehicle structural component includes an additively-manufactured (AM) structure with a first end and a second end opposing the first end. The AM structure includes a pathway from the first end to the second end. The component further includes a non-AM structure passing along the pathway from the first end to the second end, wherein the non-AM structure and the AM structure are fixedly connected to one another at a connection.

In some aspects, the techniques described herein relate to a method of forming a vehicle component including: obtaining an additively-manufactured (AM) structure with a first end and a second end opposing the first end, wherein the AM structure includes a pathway from the first end to the second end; obtaining a non-AM structure passing along the pathway from the first end to the second end; and fixedly joining the AM structure and non-AM structure to one another at a connection.

Other aspects will become readily apparent to those skilled in the art from the following detailed description, wherein is shown and described only several exemplary embodiments by way of illustration. As will be realized by those skilled in the art, concepts described herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various characteristic and aspects of the technology described herein are set forth as follows, in the appended claims, and in the drawings. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative aspects when read in conjunction with the accompanying drawings.

FIGS. 1A-D illustrate respective side views of an example Powder Bed Fusion (PBF) system usable with aspects of the disclosure during different stages of operation according to aspects of the disclosure.

FIG. 2A shows one example of a wire drawing process usable with aspects of the disclosure.

FIG. 2B shows one example of an extrusion process usable with aspects of the disclosure.

FIG. 2C shows an example of a stamping or deep drawing method and apparatus usable with aspects of the disclosure.

FIG. 2D shows an example of a rolling manufacturing method and apparatus usable with aspects of the disclosure.

FIG. 3A shows an example of a mandrel bending method and apparatus usable with aspects of the disclosure.

FIG. 3B shows one example of a push bending method and apparatus usable with aspects of the disclosure.

FIG. 3C shows one example of a roll bending apparatus and method usable with aspects of the disclosure.

FIG. 3D shows one example of a stretch forming method and apparatus usable with aspects of the disclosure.

FIG. 4 shows one example of a combined AM and non-AM structure according to aspects of the disclosure.

FIG. 5 is a partial isometric view of one example of a connected combination structure according to aspects of the disclosure.

FIG. 6 is a partial isometric view of one example of a connected combination structure according to aspects of the disclosure.

FIGS. 7A and 7B, show one example of cross-sections of an AM component and a non-AM structure according to aspects of the disclosure.

FIGS. 8A and 8B, show another example of cross-sections of an AM component and a non-AM structure according to aspects of the disclosure.

FIG. 9 is a partial isometric view of one example of a connected combination structure with an AM structure and non-AM structure according to aspects of the disclosure.

FIG. 10 is a partial isometric view of one example of a connected combination structure with an AM structure and non-AM structure according to aspects of the disclosure.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram or simplified form, or omitted entirely, to avoid obscuring the various concepts presented throughout this disclosure.

### I. Terminology

Reference throughout this specification to one aspect, an aspect, one example or an example means that a particular feature, structure or characteristic described in connection with the embodiment or example may be a feature included in at least example of the present invention. Thus, appearances of the phrases in one aspect, in an aspect, one example or an example in various places throughout this specification are not necessarily all referring to the same example. Furthermore, the particular features, structures or characteristics may be combined in any suitable combinations and/or sub combinations in one or more embodiments or examples.

The term exemplary used in this disclosure means serving as an example, instance, or illustration, and should not necessarily be construed as preferred or advantageous over other embodiments presented in this disclosure.

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable level of variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the aspects or articles described herein are in an in-use orientation. In some examples, the directional terms are expressed generally with relation to a left-hand coordinate system.

Terms such as a, an, and the, are not intended to refer to only a singular entity, but also include the general class of which a specific example may be used for illustration. The terms a, an, and the, may be used interchangeably with the term at least one. The phrases at least one of and comprises at least one of followed by a list refers to any one of the items in the list and any combination of two or more items in the list. All numerical ranges are inclusive of their endpoints and non-integer values between the endpoints unless otherwise stated.

The terms first, second, third, and fourth, among other numeric values, may be used in this disclosure. It will be understood that, unless otherwise noted, those terms are used in their relative sense only. In particular, certain components may be present in interchangeable and/or identical multiples (e.g., pairs). For these components, the designation of first, second, third, and/or fourth may be applied to the components merely as a matter of convenience in the description.

The terms powder bed fusion (PBF) is used throughout the disclosure. PBF systems may encompass a wide variety of additive manufacturing (AM) techniques, systems, and methods. Thus, the PBF system or process as referenced in the disclosure may include, among others, the following printing techniques: direct metal laser sintering (DMLS), electron beam melting (EBM), selective heat sintering (SHS), selective laser melting (SLM) and selective laser sintering (SLS). PBF fusing and sintering techniques may further include, for example, solid state sintering, liquid phase sintering, partial melting, full melting, chemical binding and other binding and sintering technologies. Although PBF processes are disclosed herein, other 3D printing processes (e.g., direct energy deposit (DED), fused deposition modeling (FDM), stereolithography (SLA), etc.) may be used without departing from the principles of this disclosure including those that are currently contemplated or under commercial development. The aspects of the disclosure may additionally be relevant to non-metal additive manufacturing and or metal/adhesive additive manufacturing (e.g., binderjetting), which may forgo an energy beam source and instead apply an adhesive or other bonding agent to form each layer. In the case of binderjetting, the cured or green form may be sintered or fused in a furnace and/or be infiltrated with bronze or other alloys.

The term fusing may be used throughout the disclosure to describe any permanent adhering of AM powder or other known materials. In some examples, the term fusing may include sintering, melting, and/or adhering (e.g., via bonding agent or adhesive) individual powder particles.

The term conventional manufacturing or non-AM may be used throughout the disclosure to encompass any manufacturing technique other than AM. Some examples may include any one or combination of subtractive manufacturing techniques (e.g., machining) and/or extrusions, stampings, forgings, moldings, or castings, to name a few non-limiting examples. Further, non-AM may refer to any known method for forming non-metallic components. For example, non-AM may also encompass components formed of composites including any one or combination of carbon fibers, para-aramid (Kevlar™), fiberglass, or substrates thereof that are bonded or otherwise laminated via a synthetic polymer (e.g., epoxy, vinyl ester, polyester resins or combinations thereof).

The term structural component in a vehicle may include but is not limited to a frame, subframe, or an component that receives a load due to vehicle driving dynamics. In some examples, the term structural component may distinguish from other vehicle components, e.g., seats, steering wheel, exhaust, etc.

### II. Detailed Examples

Additive Manufacturing (AM) systems such as powder bed fusion (PBF) systems can produce structures with geometrically complex shapes, including some shapes that are difficult or impossible to create with conventional manufacturing processes. PBF systems create build pieces layer-by-layer, i.e., slice-by-slice. Each slice can be formed by a process of depositing a layer of powder (e.g., metal or metallic powder) and fusing (e.g., melting and cooling) areas of the metal powder layer that coincide with the cross-section of the build piece in the slice. The process can be repeated to form the next slice of the build piece, and so on.

However, in some situations PBF or AM components or sections may only be required and/or may be best utilized at certain portions of an overall build or structure. For example, in the context of a vehicle component or combined component or structure, a part of a larger structure may be formed using PBF or AM due to any one or combination of efficiency concerns, packaging, desired strength, weight and/or known stresses and ability to optimize AM components to known stresses. Other sections of a vehicle component may be formed using non-AM techniques. As an overview, aspects of this disclosure are related to components and methods of forming components that include both PBF and/or AM sections as well as components formed using non-AM techniques. Further details and examples are provided in the detailed examples that follow.

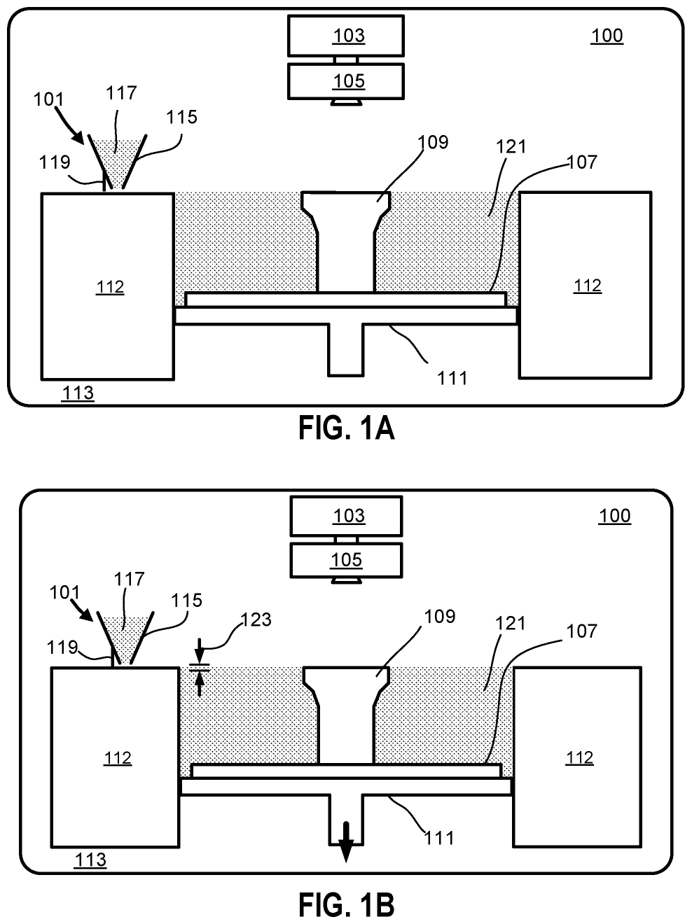

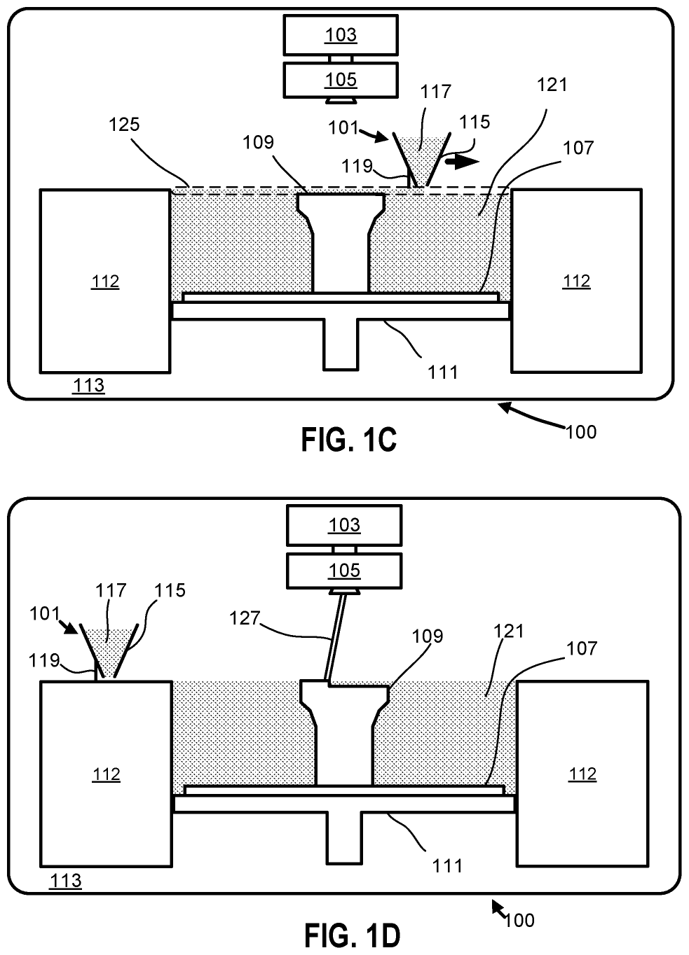

FIGS. 1A-D illustrate respective side views of an example of a PBF system 100 usable with aspects of the disclosure during different stages of operation. As noted above, the particular embodiment illustrated in FIGS. 1A-D is one of many suitable examples of a PBF system employing principles of this disclosure. It should also be noted that elements of FIGS. 1A-D and the other figures in this disclosure are simplified and not necessarily drawn to scale, but may be drawn larger or smaller and/or with reduced detail for the purpose of better illustration of concepts described herein. PBF system 100 can include a depositor 101 that can deposit each layer of metal powder, an energy beam source 103 that can generate an energy beam, a deflector 105 that can direct or redirect the energy beam to fuse and/or sinter the powder material, and a build plate 107 that can support one or more build pieces, such as a build piece 109. PBF system 100 can also include a build floor 111 positioned within a powder bed receptacle. The walls of the powder bed receptacle 112. Build floor 111 can progressively lower build plate 107 so that depositor 101 can deposit a next layer. In some examples, the entire mechanism may reside in a chamber 113 that can enclose the other components, thereby protecting the equipment, enabling atmospheric (e.g., providing an inert environment) and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused by the energy beam, but before the next layer of powder has been deposited. In fact, FIG. 1A illustrates a time at which PBF system 100 has already deposited and fused a partially completed buildpiece in multiple layers to form the current state of build piece 109. The multiple layers already deposited have created a powder bed 121, which includes powder that was deposited but not sintered and/or fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse, sinter, and/or melt the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 may include an optical system that uses reflection and/or refraction to manipulate the laser beam to scan selected areas to be fused. In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various aspects of the disclosure, the energy beam can be modulated by a digital signal processor (DSP). The deflector may include any known system in the art, for example a galvo-scanner or galvanometer, and/or a raster scanner. It is noted that while a single energy beam source 103 and/or deflector 105 is shown, aspects of the disclosure are usable with and may include a system with multiple energy source(s) and/or deflector(s).

As shown in FIG. 1D, much of the fusing of powder layer 125 occurs in areas of the powder layer that are on top of the previous slice, i.e., previously-fused powder. An example of such an area is the surface of build piece 109. The fusing of the powder layer in FIG. 1D is occurring over the previously fused layers characterizing the substance of build piece 109. The steps outlined above allow for the formation of shapes and structures that cannot otherwise be formed or would be cost-prohibitive or inefficient to form using traditional non-AM manufacturing techniques.

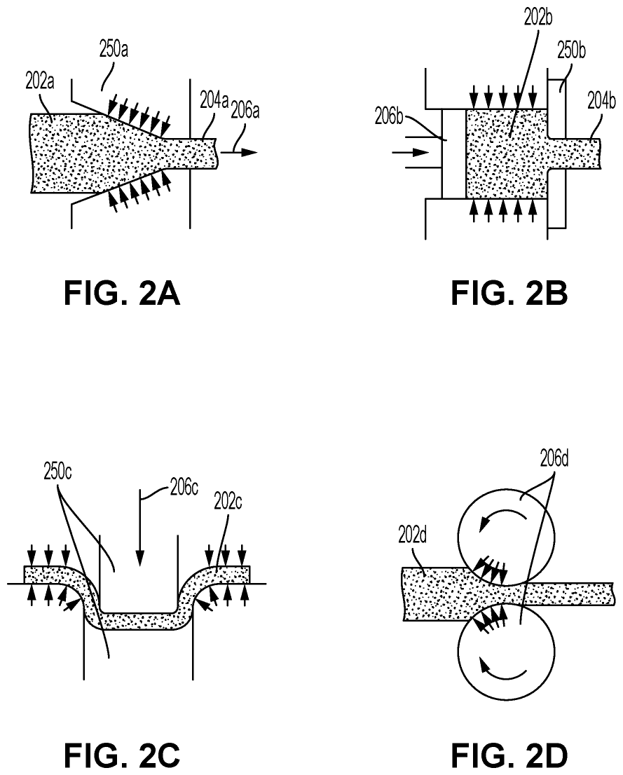

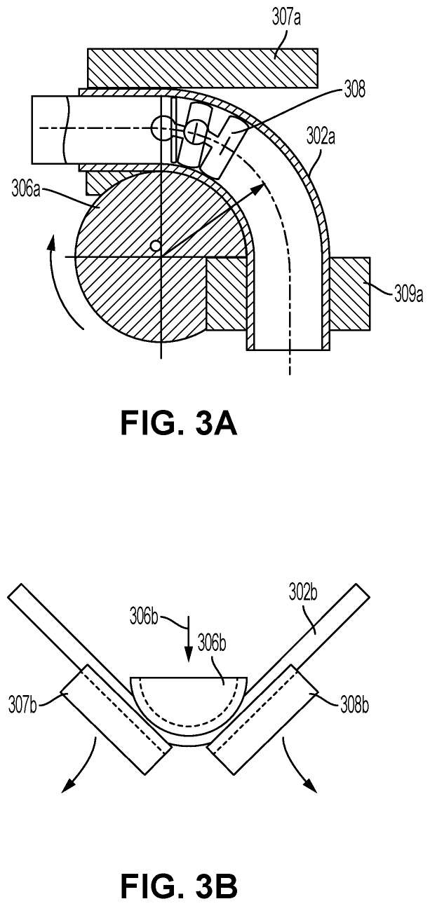

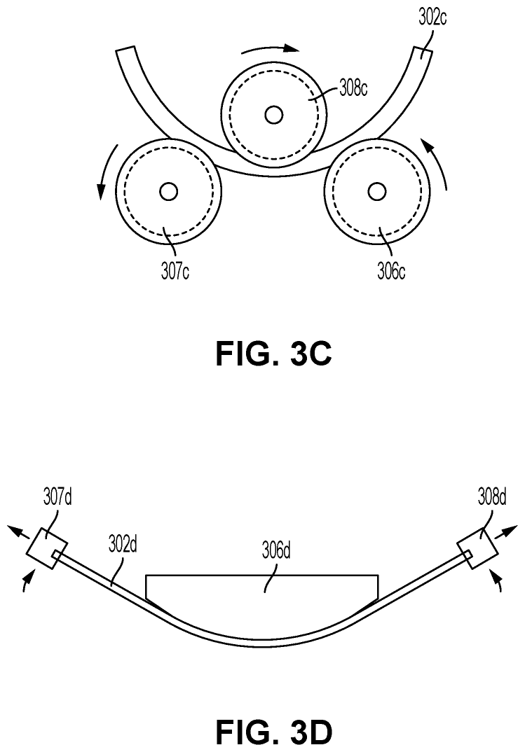

FIGS. 2A-3D show non-limiting examples of non-AM manufacturing techniques usable with aspects of the disclosure.

FIG. 2A shows an example a die drawing manufacturing method and apparatus usable with aspects of the disclosure. In die drawing, an undrawn material 202a (e.g., metal or alloy thereof) is pulled through a single die or series of dies 250a via a pulling apparatus (indicated by arrow 206a) to reduce the diameter or dimension of, change the cross-sectional shape of and/or to ensure the material is uniform in cross-section along the length thereof. The drawn material 204a that emerges from the die(s) 250a has a reduced and/or changed cross-section and/or may have altered material properties. Die drawing allows for formation of elongated component with a wide variety of cross-sections that may be post-processed or otherwise further manipulated into a desired shape by any one or combination of bending, additional die drawing extrusion steps, cutting and/or machining, to name a few examples.

FIG. 2B shows an example of an extrusion manufacturing method and apparatus usable with aspects of the disclosure. In extruding a material 202b (e.g., metal or alloy thereof), the material 202b is pressed through a die or series of dies 250b via a pressing apparatus 206b to reduce the diameter or dimension of, change the cross-sectional shape of and/or to ensure the material is uniform in cross-section along the length thereof. The extruded material 204b that emerges from the die(s) 250b have a reduced and/or changed cross-section and/or may have altered material properties. Extrusions allow for the formation of elongated components with a wide variety of cross-sections that may be post-processed or otherwise further manipulated into a desired shape by any one or combination of bending, additional extrusion steps or die drawing, cutting and/or machining, to name a few examples.

FIG. 2C shows an example of a stamping or deep drawing method and apparatus usable with aspects of the disclosure. The terms stamping and deep drawing may be interchangeable used herein. In stamping, a pressing apparatus (indicated by arrow 206c) provides a pressing force to deform a material (e.g., metal or alloy thereof) present between a die set 250c. The material 202c is permanently deformed into a desired shape or dimension.

FIG. 2D shows an example of a rolling manufacturing method and apparatus usable with aspects of the disclosure. A stock or material 202d (e.g., metal or alloy thereof) is passed through a series of die rollers 206d to reduce the thickness or otherwise permanently deform the material 202d to a desired shape.

It is noted that the aforementioned non-AM manufacturing techniques may be used alone or in combination to form a non-AM manufactured component according to aspects of the disclosure. However, the techniques described herein are merely provided as examples. Any known non-AM technique may be usable with aspects of the disclosure. Further, the aforementioned non-AM techniques may be additionally shaped or manipulated using the methods described in FIGS. 3A-3B.

FIG. 3A shows an example of a mandrel bending method and apparatus usable with aspects of the disclosure. For example, a material formed or otherwise manufactured using any of the methods described above with respect to FIGS. 2A-2D may further be formed into a desired shape via mandrel bending. FIG. 3A shows tube or other hollow body 302a, at least one bending die 306a, at least one pressure die 307a, and at least one clamp die 309a. One or more mandrels 308 may be provided inside a hollow section of the hollow body 302a to prevent wrinkling or undesired deformation of the hollow body 302a as the bending die(s) apply a rotational bending force causing the body to bend between and permanently deform into a desired shape between the bending die(s) 306a and pressure die(s) 306b, and clamp die 309a.

FIG. 3B shows one example of a push bending method and apparatus usable with aspects of the disclosure. The push bending process is applicable to a material formed or otherwise manufactured using any of the methods described above with respect to FIGS. 2A-2D and may further be formed into a desired shape via the mandrel bending process described above with respect to FIG. 3A. A force application apparatus (indicated by arrow 306b) may press one or more ram die(s) 306b into a plurality of pressure dies 307b and 308b to permanently deform a material 302b into a desired shape.

FIG. 3C shows one example of a roll bending apparatus and method usable with aspects of the disclosure. The roll bending process is applicable to a material formed or otherwise manufactured using any of the methods described above with respect to FIGS. 2A-2D and may further be formed into a desired shape via the mandrel bending process described above with respect to FIG. 3A and/or the push bending process described above with respect to FIG. 3B. The roll bending apparatus may include a plurality of bending rollers 306c, 307c, and/or 306c. The bending rollers 306c, 307c, and/or 306c may be configured to rotate about a fixed axis. The material 302c may be fed through the roller(s) 306c, 307c, and/or 308c causing permanent deformation of the material 302c in a desired shape.

FIG. 3D shows one example of a stretch forming method and apparatus usable with aspects of the disclosure. The stretch forming process is applicable to a material formed or otherwise manufactured using any of the methods described above with respect to FIGS. 2A-2D and may further be formed into a desired shape via the mandrel bending process described above with respect to FIG. 3A and/or the push bending process described above with respect to FIG. 3B and/or the roll bending process described above with respect to FIG. 2C. The stretch forming apparatus may include a bending die 306d, which may be fixed or moveable. The material 302d may have a first portion and a second portion clamped via one or more clamps 307d and/or 308d, and a pulling and/or bending force may be applied via a respective bending and/or pulling apparatus. The bending and/or pulling force applied at the one or more clamps 307d and/or 308d cause the material 302d to bend into the shape of the bending die 306d.

As noted above, any one or combination of the aforementioned non-AM methods or apparatuses may be used to form a non-AM component or structure described herein. It is noted the aforementioned non-AM methods and apparatuses are merely provided as examples. Any known non-AM method and/or apparatus may be used to form a non-AM component or structure as described herein and may be combined with any one or combination of the methods and apparatuses described herein.

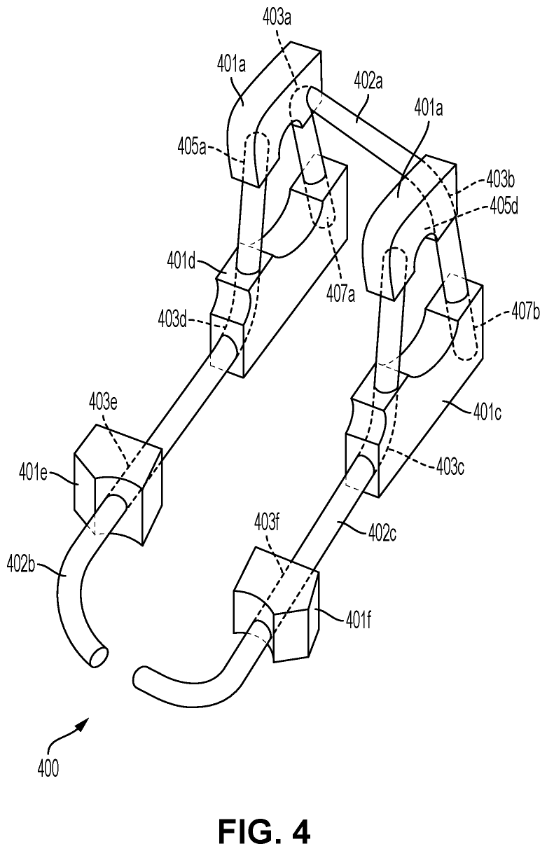

FIG. 4 shows one example of a combined AM and non-AM structure according to aspects of the disclosure. The structure 400 may include a first non-AM structure 402a, a second non-AM structure 402b and a third non-AM structure 402c. While elongated hollow bodies (e.g., tubes) are shown as example non-AM structures in FIGS. 4-6 and 9-10, it is noted that any non-AM structure is applicable to the aspects described herein. The aforementioned non-AM structures may be formed using a non-AM manufacturing technique and may have any appropriate shape. In one example, the non-AM structures may be formed using any one or combination of the methods and using the apparatuses described above with respect to FIGS. 2A-3D. In an example, the aforementioned non-AM structures may be elongated hollow or partially hollow bodies that may have a circular, oval, square, rectangular, or multi-sided cross-section.

As shown in FIG. 4, each of the non-AM structures 402a, 402b, and/or 402 may pass through one or more AM structures. For example, the first non-AM structure 402a may pass through or pass along a pathway 403a in first AM structure 401a and/or a pathway 403b in a second AM structure 402b. Ends of the first non-AM structure 402a may also be receivable within pathways 407a and/or 407b (in this case a blind-pathways, i.e., does not fully pass through the AM structure) in a third AM structure 401c and/or fourth AM structure 401d. A second non-AM structure 402b may pass through or pass along a pathway 403e in a fifth AM structure 401e, pass through or along a pathway 403d in the fourth AM structure 401d and pass into or otherwise be receivable within a pathway 405a in the first AM structure 401a, which may be a blind-pathway. A third non-AM structure 402c may pass through or pass along a pathway 403f in a sixth AM structure 401f, pass through or along a pathway 403c in the third AM structure 401c and pass into or otherwise be receivable within a pathway 405d in the third AM structure 401c, which may be a blind-pathway.

In some examples, any one, combination, or all of the AM structures discussed above may include features for mounting vehicle components thereon. For example, the AM structures may include mounting features for any one or a combination of body panels, suspension components, vehicle propulsion components, safety components, vehicle interior components and/or may be used to tie-together or otherwise structurally connect the one or more non-AM components. In one example, the structure 400 may for example be a vehicle frame or subframe. While specific examples are provided above, it is noted that the aspects described herein are applicable to any component or series of components that benefit from the combination of AM structures and non-AM structures as a structure.

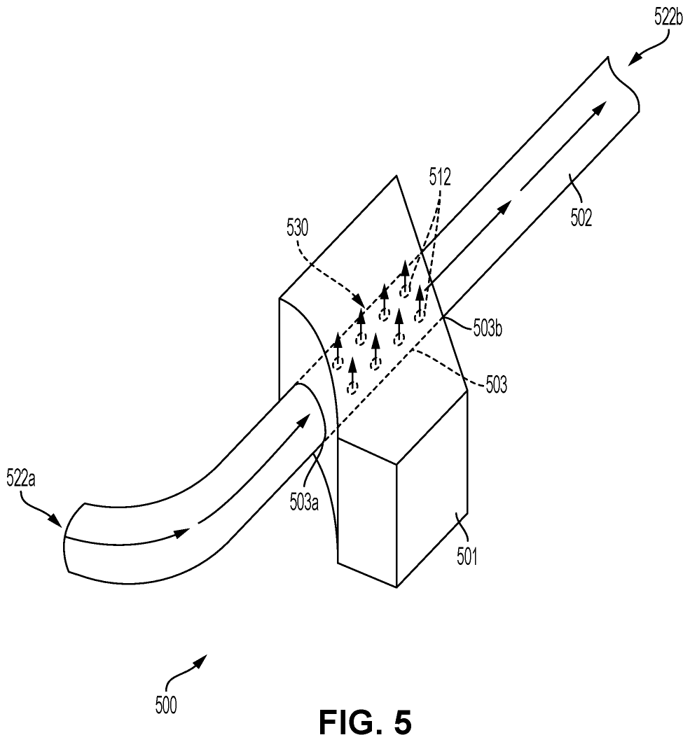

The interface between any one of or combination of the non-AM structures and AM structures described above may include features described with respect to FIGS. 5-10 below.

FIG. 5 is a partial isometric view of one example of a connected combination structure 500 comprising an AM structure and non-AM structure according to aspects of the disclosure. A non-AM structure 502 may for example be an elongated hollow body, a partial view of which is shown in FIG. 5. It is noted that while a tube-shaped structure is shown, aspects of this disclosure are applicable to any non-AM structure subject to any processing or manufacturing method (additional examples of which are described above with respect to FIGS. 2A-3D). In one example, the non-AM structure 502 may share features with or may be analogous with any one or combination of the first non-AM structure 402a, the second non-AM structure 402b, and/or the third non-AM structure 402c in FIG. 4.

The non-AM structure 502 may have a first end 522a and a second end 522b. The non-AM structure 502 may also include an engagement portion or region 530 that is configured to be passed along a pathway 503 in an AM component 501. The AM component 501 may for example be hollow or partially hollow and may include a first end opening 503a and a second end opening 503b configured to have the non-AM structure 502 passed therethrough.

As shown in FIG. 5, the non-AM structure 502 may have perforations or passages 512. In one example, the passages 512 may be a series of holes or other openings that provide fluid communication from the inside of a hollow passage in the non-AM structure 502 to an outside or exterior of the non-AM structure 502. Once the non-AM structure 502 is passed through the first end opening 503a and the second end opening 503b of the AM component 501 and the engagement part or region 530 is aligned so that the passages 512 are within the AM component 501, an adhesive or other connection media may be injected or otherwise provided into one of or both of the first end 522a and/or second end 522b of the non-AM structure 502. The connection media then passes through the passages 512 of the non-AM structure 502 and into the AM component 501. Once the adhesive or connection media is cured, the non-AM structure 502 and the AM component 501 may be permanently connected at the connection to form the combination structure 500.

The aforementioned connection media may be any known adhesive or foaming adhesive. In some aspects, the connection media may be a two part curable adhesive such as an epoxy, urethane or urethane foam, expanding or foaming adhesive, or other adhesive. In another example, the adhesive and/or foam may cure when heat is applied and thus the connected combination structure 500 may be placed in an autoclave or oven to cure the adhesive at the connection.

It is noted that while the specific example above mentions the adhesive or connection media being added to the non-AM structure 602, the adhesive or connection media may be added to an opening or passage in the AM component 501 either as an alternative or in combination with the aspects described above. In this example, the adhesive or connection media may be added to the AM structure 602 and may flow from the AM structure 602 to the inside passage of the non-AM structure 502.

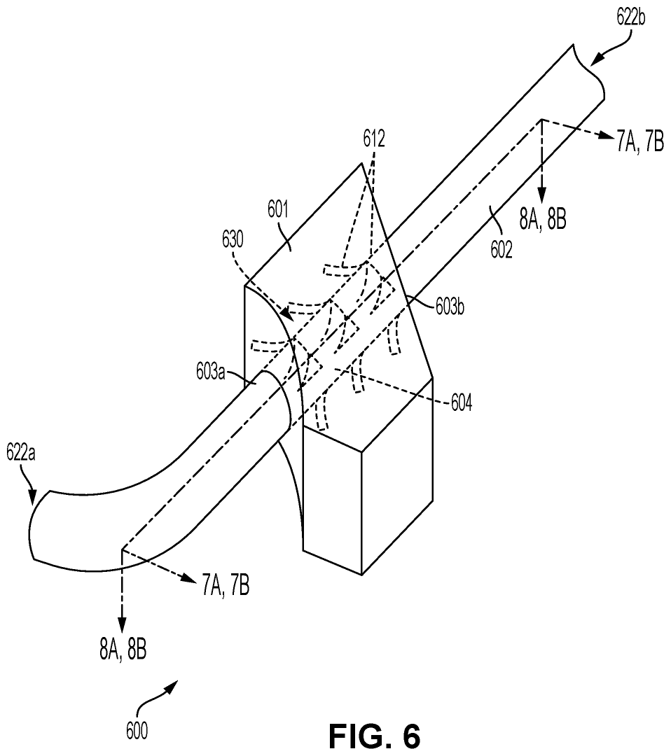

FIG. 6 is a partial isometric view of one example of a connected combination structure 600 comprising an AM structure and non-AM structure according to aspects of the disclosure. A non-AM structure 602 may for example be an elongated hollow body, a partial view of which is shown in FIG. 6. It is noted that while a tube-shaped structure is shown, aspects of this disclosure are applicable to any non-AM structure subject to any processing or manufacturing method (additional examples of which are described above with respect to FIGS. 2A-3D). In one example, the non-AM structure 502b may share features with or may be analogous with any one or combination of the first non-AM structure 402a, the second non-AM structure 402b, and/or the third non-AM structure 402c in FIG. 4.

The non-AM structure 602 may have a first end 622a and a second end 622b. The non-AM structure 602 may also include an engagement portion or region 630 that is configured to be passed along a pathway 603 in an AM component 601. The AM component 601 may for example be hollow or partially hollow and may include a first end opening 603a and a second end opening 603b configured to have the non-AM structure non-AM structure 602 passed therethrough. Throughout the disclosure the term passage or hollow may be used, however it is noted that while specific examples are provided herein, a pathway could include a hollow body or passage, but may also include partially hollow (e.g., partly open to the outside), and also exposed surfaces (e.g., a flat or contoured surface on the outside of the AM structure, so that the non-AM structure isn't threaded through the AM structure, but rather the AM structure simply sits on or partially in the non-AM structure or vice-versa. For example, the pathway could instead be an open pathway.

As shown in FIG. 5, the non-AM structure 602 may have one or more deformable features 612. In one example, the deformable features may be tab-shaped cutouts with one end or side connected to the non-AM structure 602. The deformable features 612 may for example be rectangular tabs with three sides cut or otherwise detached from the non-AM structure 602 so that application of pressure causes the one or more deformable features 612 to bend. While the one or more deformable features 612 are shown as a series of nine rectangular tabs in FIG. 6, any number or shape deformable feature(s) may be used without departing from the scope of this disclosure. In one example, once the one or more deformable features 612 are bent, a passage that provides a fluid communication from the inside of a hollow passage in the non-AM structure 502 to an outside or exterior of the non-AM structure 502 may be formed.

Once the non-AM structure 602 is passed through the first end opening 603a and the second end opening 603b of the AM component 601 and the engagement part or region 630 is aligned so that the deformable features 612 are within the AM component 601, an adhesive or other connection media may be injected or otherwise provided into one of or both of the first end 722a and/or second end 722b of the non-AM structure 702. Pressure may be built up in the non-AM structure 602 either by pressurizing and/or suppling the adhesive or connection media into the non-AM structure 602 at pressure causing the one or more deformable features 612 to bend as shown in FIG. 6. The bending of the one or more deformable features 612 may effectively lock or otherwise connect the AM component 601 to the non-AM structure 602.

In some examples, the connection media may also pass through the passages formed in the non-AM structure 602 when the one or more deformable features 612 are deformed causing the connection media to flow into the AM component 601. Once the adhesive or connection media is cured, the non-AM structure 602 and the AM component 601 may be permanently connected at the connection to form the combination structure 600. The combination of the one or more deformable features 612 engaging or otherwise expanding into the AM component 601 and the connection media curing between the AM component 601 and the non-AM structure 602 may further strengthen the connection between the two components and prevent loosening or failure of the connection due to torsional loads and/or pull-push loads, for example.

The aforementioned connection media may be any known adhesive or foaming adhesive. In some aspects, the connection media may be a two part curable adhesive such as an epoxy, urethane or urethane foam, expanding or foaming adhesive, or other adhesive. In another example, the adhesive and/or foam may cure when heat is applied and thus the connected combination structure 600 may be placed in an autoclave or oven to cure the adhesive at the connection.

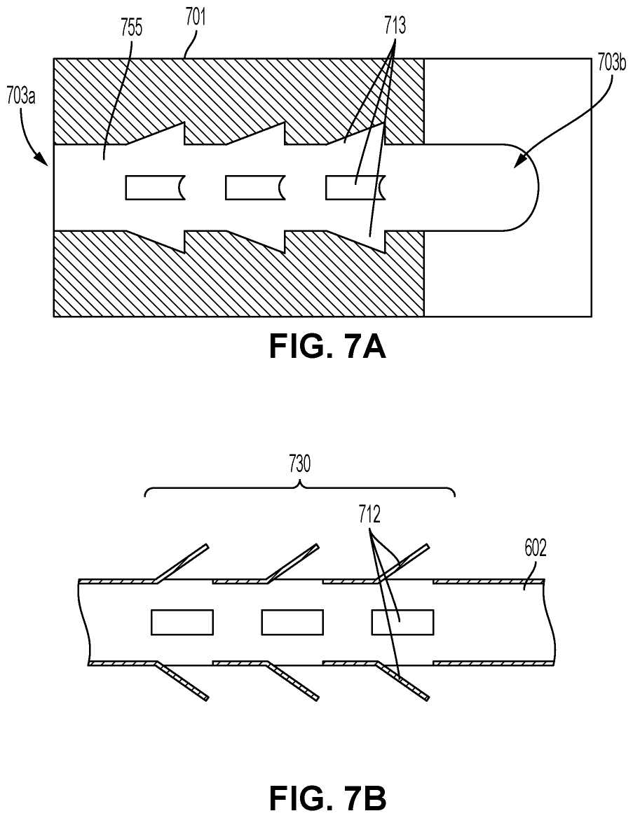

FIGS. 7A and 7B, show one example of cross-sections of an AM component 701 and a non-AM structure according to aspects of the disclosure. In one example, the AM component 701 and non-AM structure 702 may share features with or may be analogous with the AM component 601 and non-AM structure 602 described above with respect to FIG. 6.

As shown in FIGS. 7A and 7B, the AM component 701 may have a passage or pathway 755 that extends from an opening at a first end 703a and a second end 703b. The pathway 755 may for example have one or more receiving features 713 that are configured to receive one or more deformable features 712 at a connection region 730 of the non-AM structure 702. When the one or more deformable features 712 are deformed and bent outward as shown in FIG. 7B, the one or more deformable features 712 lock-into or otherwise expand into the one or more receiving features 713 thus further strengthening the bond at the connection of the AM component 701 and the non-AM structure 702.

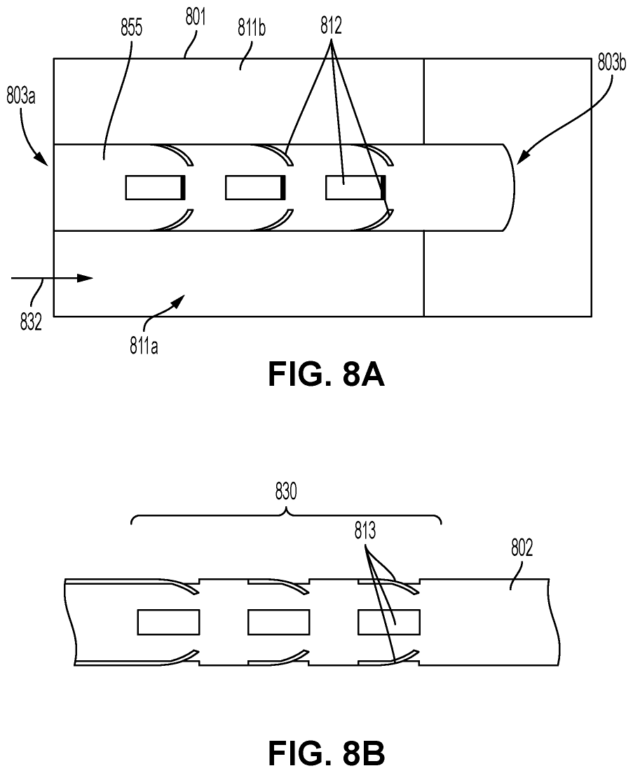

FIGS. 8A and 8B, show another example of cross-sections of an AM component 801 and a non-AM structure 802 according to aspects of the disclosure. In one example, the AM component 801 and non-AM structure 802 may share features with or may be analogous with the AM component 601 and non-AM structure 602 described above with respect to FIG. 6. Further, as noted above, the features described above with respect to FIGS. 7A and 7B may be used in combination with the features described below (i.e., both the non-AM structure and the AM component may have deformable features and corresponding receiving features).

As shown in FIGS. 8A and 8B, the AM component 801 may have a passage or pathway 855 that extends from an opening at a first end 703a and a second end 703b. The pathway 755 may for example have one or deformable features 812. The deformable features 812 may for example be rectangular tabs with three sides detached from the pathway 855 so that application of pressure causes the one or more deformable features 812 to bend. While the one or more deformable features 812 are shown as a series of nine rectangular tabs in FIGS. 8A and 8B, any number or shape deformable feature(s) may be used without departing from the scope of this disclosure.

The non-AM structure 802 in FIG. 8B may additionally include one or more receiving features 813 that correspond with the one or more deformable features 812 and that are configured to receive the one or more deformable features 812 at a connection region 830 of the non-AM structure 802. When the one or more deformable features 812 are deformed and bent inward into the pathway 855 as shown in FIG. 8A, the one or more deformable features 812 lock-into or otherwise expand into the one or more receiving features 813 thus locking the AM component 801 and the non-AM structure 802 at the connection.

Similarly to the aspects described above, in one example, once the one or more deformable features 812 are bent, a passage that provides a fluid communication from the inside of a hollow passage in the AM component 801 to the pathway 855 and into the one or more receiving features 813 may be formed. Thus, when an adhesive or other connection media is injected or otherwise provided into the AM structure (i.e., as indicated by arrow 832, pressure may be built up in the AM component 801 either by pressurizing and/or suppling the adhesive or connection media into the AM component 801 causing the one or more deformable features 812 to bend as shown in FIG. 8A. The bending of the one or more deformable features 812 into the one or more receiving features 813 and curing of any adhesive provided therein may effectively lock or otherwise connect the AM component 801 to the non-AM structure 802 to form a combined structure. The combination of the one or more deformable features 812 engaging or otherwise expanding into the one or more receiving features 813 and the curing of the connection media between the AM component 801 and the non-AM structure 802 may further strengthen the connection between the two components and prevent loosening or failure of the connection due to torsional loads and/or pull-push loads, for example.

While the examples provided above describe providing a connection media at pressure or a connection media that builds in pressure to deform or otherwise expand the one or more deformable features (e.g., 612 in FIG. 6, 712 in FIG. 7, and/or 812 in FIG. 8), the one or more deformable features may instead be deformed or expanded by a mechanical apparatus such as a borescope with a pressing or expansion device that can provide a bending force to the deformable features. Further, the borescope may additionally include a connection media or adhesive dispenser for dispensing a connection media at the connection when the deformable features are expanded or deformed. In another example, a mandrel with expandable features that correspond to each of the deformable features may be passed into a passage of either the AM component and/or non-AM structure and expanded. The expansion of the expandable features may in turn bend the expandable features as described above.

In one example usable with the aspects above that provides additional advantages, a high pressure gas and/or vacuum and/or a detergent or etching agent may be introduced into the AM component and/or non-AM component to remove any unfused powder and/or contaminants that are present in the AM structure.

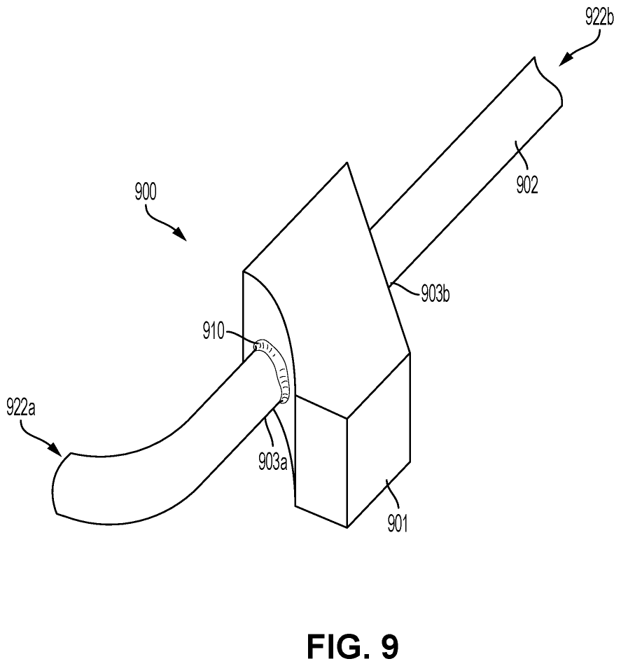

FIG. 9 is a partial isometric view of one example of a connected combination structure 900 comprising an AM structure and non-AM structure according to aspects of the disclosure. A non-AM structure 902 may for example be an elongated hollow body, a partial view of which is shown in FIG. 9. It is noted that while a tube-shaped structure is shown, aspects of this disclosure are applicable to any non-AM structure subject to any processing or manufacturing method (additional examples of which are described above with respect to FIGS. 2A-3D). In one example, the non-AM structure 902 may share features with or may be analogous with any one or combination of the first non-AM structure 402a, the second non-AM structure 402b, the third non-AM structure 402c in FIG. 4, 502 in FIG. 5, 602 in FIG. 6, 702 in FIGS. 7A and 7B and/or 802 in FIGS. 8A and 8B. The connection between the non-AM structure 902 and the AM component described below may be used as an alternative to or in combination with any of the connections described herein.

The non-AM structure 902 in FIG. 9 may have a first end 922a and a second end 922b. The non-AM structure 902 may also include an engagement portion or pass-through region that is configured to be passed along a pathway in an AM component 901 from a first end 903a to a second end 903b. The AM component 901 may for example be hollow or partially hollow and/or include a passageway that connects the opening in the first end 903a to the second end 903b. Once the non-AM structure 902 is passed through and along the aforementioned pathway and appropriate oriented with respect to the AM component 901, the two may be fixed or otherwise connected at a connection 910. It is noted that while only a single connection 910 is visible in FIG. 9, a similar connection may be present at second end 903b (which is hidden from view in FIG. 9).

The connection 910 may for example be formed by welding or otherwise fixing or adhering the non-AM structure 902 to the AM component 901. In some examples, the connection may be formed via a weld. Some examples of suitable weld connections may include but are not limed to any one or combination of a tungsten inert gas weld (TIG), a metal inert gas weld (MIG), a stir weld, a friction weld to name a few examples. Further, the connection may be formed via a supersonic particle deposition process, frequently referred to as a cold spray weld. In one example, the cold spray weld may be formed by using an electrically heated high-pressure carrier gas to accelerate metal powders through a supersonic de Laval nozzle above a critical velocity for particle adhesion. The cold spray bonding mechanism may be a combination of mechanical interlocking and metallurgical bonding from re-crystallization at highly strained particle interfaces.

In one example, the outer surface of non-AM structure 902 and the passage of the AM component 901 may have corresponding threaded surfaces allowing the non-AM structure 902 to be threaded into the AM component 901. In some examples, any of the additional connection methods described herein may be combined with the threading of the non-AM structure 902 into the AM component 901 to further strengthen the connection.

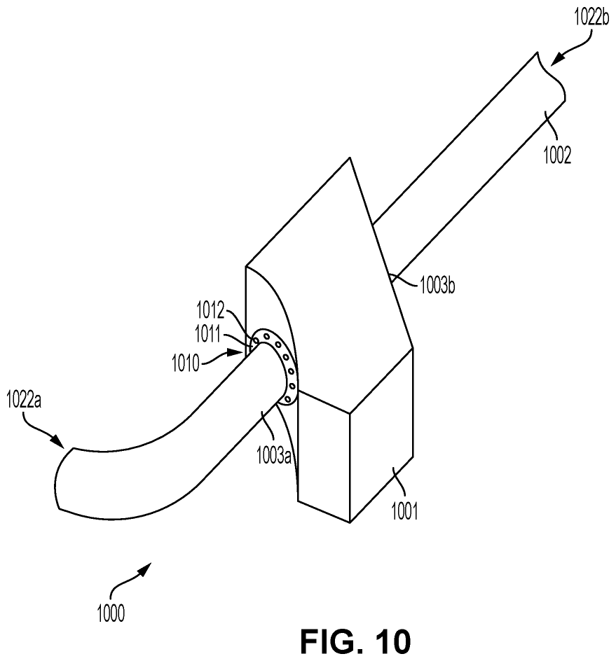

FIG. 10 is a partial isometric view of one example of a connected combination structure 1000 comprising an AM structure and non-AM structure according to aspects of the disclosure. A non-AM structure 1002 may for example be an elongated hollow body, a partial view of which is shown in FIG. 10. It is noted that while a tube-shaped structure is shown, aspects of this disclosure are applicable to any non-AM structure subject to any processing or manufacturing method (additional examples of which are described above with respect to FIGS. 2A-3D). In one example, the non-AM structure 1002 may share features with or may be analogous with any one or combination of the first non-AM structure 402a, the second non-AM structure 402b, the third non-AM structure 402c in FIG. 4, non-AM structure 502 in FIG. 5, 602 in FIG. 6, 702 in FIGS. 7A and 7B, 802 in FIGS. 8A and 8B, and/or 902 in FIG. 9. The connection between the non-AM structure 1002 and the AM component described below may be used as an alternative to or in combination with any of the connections described herein.

The non-AM structure 1002 in FIG. 10 may have a first end 1022a and a second end 1022b. The non-AM structure 1002 may also include an engagement portion or pass-through region that is configured to be passed along a pathway in an AM component 1001 from a first end 1003a to a second end 1003b. The AM component 1001 may for example be hollow or partially hollow and/or include a passageway that connects the opening in the first end 1003a to the second end 1003b. Once the non-AM structure 1002 is passed through and along the aforementioned pathway and appropriate oriented with respect to the AM component 1001, the two may be fixed or otherwise connected at a connection 1010. It is noted that while only a single connection 1010 is visible in FIG. 10, a similar connection may be present at second end 1003b (which is hidden from view in FIG. 10).

The connection 1010 may for example be formed by bolting, riveting, or otherwise fastening the non-AM structure 1002 to the AM component 1001. In some examples, the non-AM structure 1002 and/or the AM component 1001 may have a flange 1011 configured to have one or more fasteners 1012 passed therethrough. Some examples of suitable fasteners include but are not limited to any one or combination of rivets, bolts, screws or self-tapping fasteners, clips and the like. It is noted that whild only a single connection 1010 is shown in FIG. 10, the combination structure 1000 may include additional connections. For example, similar flange 1011 and one or more fasteners 1012 may be present at second end 1003b (which is hidden from view in FIG. 10). Further, the features described with respect to FIG. 10 may be combined with any one or combination of the connection features and methods described herein.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other support structures and systems and methods for removal of support structures. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A vehicle structural component comprising:
an additively-manufactured (AM) structure with a first end and a second end opposing the first end, wherein the AM structure includes a pathway from the first end to the second end;
a non-AM structure passing along the pathway from the first end to the second end, wherein the non-AM structure and the AM structure are fixedly connected to one another at a connection.

2. The vehicle component of claim 1, wherein the connection includes at least an adhesive, a weld, a cold-spray weld, or a deformable feature.

3. The vehicle component of claim 2, wherein the connection includes the adhesive, and the non-AM structure includes an opening and an internal portion connecting the opening to the connection, wherein the internal portion is configured to flow the adhesive from the opening to the connection.

4. The vehicle component of claim 3, wherein the adhesive is an expanding adhesive, wherein an expansion of the expanding adhesive causes a flow of the expanding adhesive through the internal portion

5. The vehicle component of claim 1, wherein at least the AM structure or the non-AM structure further include a deformation feature configured to deform to form at least part of the connection.

6. The vehicle component of claim 5, wherein the connection includes an adhesive, the non-AM structure includes an opening and an internal portion connecting the opening to the connection, and a flow of the adhesive through the internal portion deforms the deformation feature to form at least part of the connection.

7. The vehicle component of claim 5, wherein the deformation feature is configured to deform in response to pressure variations caused by at least a fluid pressure or a mechanical force.

8. The vehicle component of claim 1, wherein the pathway includes a hollow pathway through the AM structure, and a portion of the non-AM structure passes through the AM structure through the pathway.

9. The vehicle component of claim 1, wherein the pathway includes an open pathway.

10. The vehicle component of claim 1, wherein the non-AM structure is at least: a stamped component, an extruded component, a drawn over mandrel formed component; a machined component, or a composite component.

11. The vehicle component of claim 10, wherein the composite component comprises at least one of a carbon fiber, a para-aramid fiber, or a glass fiber.

12. The vehicle component of claim 1, wherein the non-AM structure is an elongated tube or closed shape.

13. The vehicle component of claim 11, wherein the non-AM structure has a curved section, wherein the curved section is fixedly connected to the connection.

14. A method of forming a vehicle component comprising:
obtaining an additively-manufactured (AM) structure with a first end and a second end opposing the first end, wherein the AM structure includes a pathway from the first end to the second end;
obtaining a non-AM structure passing along the pathway from the first end to the second end; and
fixedly joining the AM structure and non-AM structure to one another at a connection.

15. The method of claim 14, wherein fixedly joining the AM structure to the non-AM structure comprises at least using an adhesive, welding, cold-spray welding, or deforming a deformable feature.

16. The method of claim 15, wherein the non-AM structure further comprises a passage and an opening at the connection that is in fluid communication with the passage, wherein using an adhesive comprises:
providing an adhesive to the passage so that the adhesive flows from the opening to the connection.

17. The method of claim 16, wherein the adhesive is an expanding adhesive, wherein an expansion of the expanding adhesive causes the flow of the expanding adhesive through the passage and opening.

18. The method of claim 14, wherein at least the AM structure or the non-AM structure further include a deformation feature, wherein fixedly joining the AM structure and the non-AM structure comprises deforming the deformation feature to form at least part of the connection.

19. The method of claim 18, wherein the deformation feature is deformed via a force provided by a flow of adhesive.

20. The method of claim 18, wherein the deformation feature deforms in response to pressure variations caused by at least a fluid pressure or a mechanical force.

21. The method of claim 14, wherein the pathway includes an open pathway.
